(19) United States
(12) Patent Application Publication
(10) Pub. No.: US 2002/0091460 A1
(43) Pub. Date: Jul. 11, 2002

(54) Hybrid CNC control system

(76) Inventor: William D. Allen, Arlington, TX (US)

Correspondence Address: JAMES L. JACKSON, ANDREWS & KURTH-MAYOR, DAY, CALDWELL, & KEETON, L.L.P., 700 LOUISIANA, SUITE 1900, HOUSTON, TX, 77002, US

(21) Appl. No.: 10/016,519

(22) Filed: Oct. 30, 2001

Related U.S. Application Data
(63) Continuation-in-part of application No. 09/534,783, filed on Mar. 24, 2000, now abandoned.
Application No. 09/534,783 is a continuation-in-part of application No. 09/586,336, filed on Jun. 2, 2000, now abandoned.

(51) Int. Cl. G06F 19/00

(52) U.S. Cl. 700/173; 700/28

(57) ABSTRACT

The present invention demonstrates an improved CNC Control system, which integrates operator-induced changes into the pre-programmed CNC machining process. The improved CNC Control system develops a Human Activity Storage Program (HASP), which is used for subsequent production in conjunction with and simultaneously with the Numerical Control Program thereby enhancing the production process by integrating the skilled machinist's input into the production process.

The numerical control program of a CNC machine is interfaced with an IBM compatible personal computer (PC) to make information relative to the block number, feed-rate and/or spindle speed over-ride values available at the personal computer. If the CNC Control has been re-configured properly (with regard to the ladder interface and operating system) a PC computer is not required. During the machining of a part the machine operator will manually over-ride the feed-rate and/or the spindle speed to optimize machining performance. Through the use of VISUAL BASIC OR C++programming modules and routines, the spindle speed and feed-rate controls (located at the CNC Control) are polled at frequent or 5OO ms intervals. The status or over-ridden values of these controls are correlated to the active block number in use during each polled sequence and this information is written to an “event file”. After the subject part has been completed, one of two options can be used. An “edit phase” is initiated which utilizes the information in the “event file” to reconstruct the MCD file. After the edit phase is complete, the resultant output “Optimized MCD” can be used to produce like parts with confidence that all motion is running at peak performance and all programmed trajectories are maintained. The cycle can be repeated again (if desired) to ensure even greater efficiency while cutting. In the alternative, the event file can be employed to “command” the CNC Control with respect to feed-rate and/or spindle speed over-ride settings.

This is a continuation-in-part of the subject matter set forth in U.S. patent application Ser. No. 09/586,336, filed on Jun. 2, 2000 by William D. Allen and entitled “Dynamic Feed Control Optimization System For CNC Machining, abandoned, which is a continuation-in-part of the subject matter of U.S. patent application Ser. No. 09/586,336, filed on Mar. 24, 2000 by William D. Allen and also entitled “Dynamic Feed Control Optimization System For CNC Machining, also abandoned.

### BACKGROUND OF THE INVENTION

1. Field of the Invention

The technical field of the present invention involves the method of operation of numerically controlled machine tools. The present invention relates generally to CNC machines typically for repetitive, high productivity metal cutting operations. More particularly, the present invention is directed to a system to improve the productivity of a CNC machine tool by automatically electronically incorporating machine operator manually induced changes to any of the various manually controllable machine function override controls, such as feed-rate, spindle speed, coolant type selector, work light on/off, conveyor on/off, jog select activation, manual positioning of axis, or the like, that are made by the machine operator, for optimizing actual machining of a part and thus for subsequent optimized production of like parts by the CNC machine.

2. Description of the Prior Art

When machining complex parts on a CNC mill or lathe, all of the factors influencing productivity come together at the machine tool. These factors include, programmer's ability, CAM system used, material types, cutter types, cutter performance, machine and holding fixture rigidity, and even the shape of the part. No known CAM system, adaptive control system or automated optimization system can positively influence the productivity of a CNC machine as effectively as a skilled machinist actively “driving” the feed and speed over-ride controls and activating the various features of the CNC machine tool while running the actual part. The term “driving” should be understood as an intentional effort being made by the machinist to improve the process by speeding up the feeds or speeds when it is appropriate or slowing down the feeds and speeds as necessary to prevent cutter breakage, improve surface finish, diminish chatter or prevent undue stress on features of the part or holding fixture.

It can be extremely beneficial to provide influence to the feeds and speeds beyond the capabilities of the N/C Program or the benefits realized by adaptive control systems. As an example: If, during the machining of a complex part, the operator detects chatter on an unusually thin wall, he may slow down the rpm or speed up the feedrate to overcome this condition. N/C Programming personnel cannot easily identify these situations during the programming process and this type of problem will not normally cause in increase in torque or pressure on the spindle sensor of an adaptive control system and therefore the problem cannot be over-come without manually re-working the N/C Program.

Another example of the benefits of applying human intervention to the optimization process is realized when machining aircraft honeycomb core materials. This material is challenging because at intermittent times during machining, as the cutter disengages from the material, a tearing action may be encountered. This tearing action is not always predictable by the N/C Programmer and cannot be overcome by adaptive control systems. The machinist, however, can over-ride the machine tool and reliably correct the situation. It is beneficial then, to be able to apply his over-rides on an automated basis through a practical application. The “driving” of the overrides can be envisioned then, as a process used to fine tune continuous path machining, improving the cutting process by speeding it up and smoothing it out or slowing it down in a way that no other system can.

The optimization efforts made by the expert machinist will in most cases, result in a plurality of feed-rates and spindle speeds within single blocks of information at various times throughout the machining process. This is an important feature of the present invention because it can be advantageous to vary the over-rides several times within in a single block of information. As an example: When milling the side of a linear flange or wall, the N/C program will normally contain one block of information with one associated feed-rate to cut the entire length of the flange. If the height of the flange increases during the cut, the amount of material being removed by the side of the cutter increases thus, the machinist may wish to slow down the feed. Continuing on, if the flange height begins to decrease within this same block, the machinist may wish to increase the feed in order to speed up the process. This action of changing the feed-rate over-ride will result in multiple feeds within one block of information. It is important to be able to duplicate this practice by an efficient and effective means.

Therefore, it is an object of the present invention to provide the capability for accurately recording the efforts made by a skilled machinist to optimize the machining process with respect to the feed-rate and spindle speed override control functions. It is also an object of the present invention to utilize those previously recorded actions to reliably duplicate the process established by the N/C Program as run by a skilled machinist. It is another object of the present invention to integrate the processing of the N/C program with an additional controlling database thereby allowing both sources of data to be simultaneously used to control the CNC machine tool. It is yet another object of the present invention to provide a method of establishing and re-playing on command, a plurality of feed-rates and spindle speeds within one block of information on a CNC machine tool. It is another object of the present invention to implement into production, any manually activated device or function monitored and detected by the PMC or PLC controller. These functions include but are not limited to feed-rate over-ride, spindle speed over-ride, coolant type selector, work light on/off, chip conveyor on/off, table rotation, door open/close, spin window on/off, jog select, manual positioning of the axis of the machine tool.

U.S. Pat. No. 5,291,416, issued to Charles S. Hutchins, is titled “Event Feedback for Numerically Controlled Machine Tool and Network Implementation Thereof”. This prior art teaches a method of managing and improving processes by attaching a network of computers to one or more machine tools in order to monitor the manufacturing process by building a file which contains “significant events” such as cycle start, feed hold and feed-rate over-rides. It is an object of the invention of Hutchins to provide data responsive the “significant events”, not for controlling subsequent machine operations, but for review at a later time. The review of this data is intended to enable programmers to accomplish accurate improvements to N/C Programs and manufacturing methods. Additional discussions concerning events established by feed-rate over-rides are discussed in the specification of the Hutchins patent. It is apparent that the intent of Hutchins is to monitor the operators use of the override controls for further manufacturing engineering review because the linked computer (20) can forward data only to the management and engineering system computers (30, 40, 50). Thus, no closed loop system exists for automatically incorporating operator manipulations of the feedrate or spindle speed over-ride controls. The Hutchins patent also states “Greater feedback provides additional information to industrial/manufacturing engineers permitting them to make substantiated decisions for improving the processes occurring at the machine tools.” This is further evidence that the system is not intended to automatically optimize machine performance or use the operator's skills to influence the machining process directly.

An extremely important point to consider when reviewing the capabilities of the Hutchins patent is the systems inability to determine the relative point in time, within a block of information, that a feed-rate or spindle speed over-ride was imposed. This is important because if multiple feeds and speeds within a block are developed because of operator induced changes, the replay system must be able to determine when (within the block) the over-ride is to take place. The Hutchins system does not track this important information and also does not record the point in time that a typical motion block became active. It therefore cannot contain the information necessary to optimize a program with various feed-rates or spindle speeds derived from a single block of information.

Another system under review is the invention set forth in U.S. Pat. No. 4,078,195 titled “Adaptive control System for Numerically Controlled Machine Tools” and issued to Mathias et al. Adaptive control systems modify the active feedrate at various times in the machining process in response to the actual forces detected by sensors equipped on the CNC machine tool. Pre-programmed reference milling forces and feed-rates are established based on the material being machined, cutter size, depth of cut and the characteristics of the machine tool. The system referenced includes a means of incorporating manual process control inputs and machine constant data storage to provide additional capability.

The productivity improvements attributed to adaptive control systems are well known and substantial. The differences between the teachings of the prior art of adaptive control and the current subject invention involve several aspects. The first aspect regards how additional control information is derived. In the current application, the optimization data is derived from an experienced machinist and this information is permanently stored in a file that is separate from the machine control data file of the machine control. The experienced machinist may deem it appropriate to activate over-rides or other functions that or not related to detectable cutting pressures. The current application is capable of saving any operator induced change for future use but in adaptive control systems, the optimization data is derived from sensors and is not saved but is used immediately to influence the process. The obvious difference between the two systems is the sensors used in an adaptive control system are always in a state of change and every subsequent part will be machined at a slightly different feed-rate as cutters dull. A second difference between adaptive control and the subject invention is the adaptive control optimization process is limited to feed-rate changes and excludes spindle speed changes and other manually activated functions. The subject invention optimizes by implementing any manually activated CNC function into the automated process at exactly the correct time not only within the program, but also, within the block.

Clearly, the teachings of event feedback and adaptive control, while meaningful, do not provide the tools necessary to accomplish the objectives stated. Adaptive control systems cannot detect delicate fixturing, which may not provide adequate support of the work piece during machining. An experienced machinist can determine unstable situations well before damage occurs and because of this, the machinist can slow down feeds or speeds based on experience and judgment. The present optimization system automatically saves the expert machinists intervention and applies the machinists knowledge automatically on subsequent production. The combined teachings of the two previously discussed systems, do not provide the utility of capturing and implementing into production the machinists inputs and over-rides.

Computer numerical control (CNC) machinery is used world wide in the aerospace, automotive, shipping, oil & gas, tool & die, injection mold, and woodworking industries. CNC machines were developed in the early to mid 1960's under the direction of the U.S. Department of Defense with assistance and co-operation of several universities and private aerospace corporations. The purpose of developing the technology was to enable industry to manufacture more advanced and complex aerospace components accurately and efficiently with semi-skilled labor.

CNC machinery is used to machine aluminum, titanium, steel, plastic, or any machineable material into complex shapes by means of computer generated commands established by an N/C Programmer. The CNC computer reads these commands, contained in a machine control data (MCD) file, one block at a time, instructing the machine to position to specific co-ordinates at a pre-determined rate of speed. This process is controlled, in that the operator normally does not modify the co-ordinates specified in the program. However, the speeds and feeds within the program can be and are often manually “over-ridden” by the machine tool operator by adjusting feed-rate and spindle speed control knobs of the CNC machine to suit the particular cutting conditions encountered during production.

A major challenge facing manufacturing companies is to ensure that costly machine tools are operated at optimum performance levels. Quite often, the N/C program is adequate for producing dimensionally correct parts, but the productivity level may be inferior. Generally, the feed rates established by the programmer are based on his level of knowledge or his concern to make a visually aesthetic part rather than to optimally utilize the CNC Machine. Additionally, the N/C Programmer's selection of proper feed-rates may be adequate during some cut sequences but too slow or too fast for others. To overcome these shortcomings, an experienced machine tool operator will normally manually adjust the feed-rate and spindle speed over-ride controls throughout the machining process to prevent cutter breakage, improve surface finish, or enhance the productivity of the machine. However, this practice requires the operator to devote continuous attention to the machining process to make manual speed and/or feed adjustments for all subsequent parts in the production run.

### Previous Methods Used for Optimization

Historically, several methods have been utilized to improve CNC machine productivity through optimization.

1) Adaptive control has been used to measure or sense pressures on machine tool spindles or sensors placed around the machine tool.

2) The N/C programmer may watch the machining process and modify the program as required to improve productivity. This method is time consuming, costly and quite often, leads to programming errors and damaged parts.

3) CG Tech of California offers a product called “Opti-Path”. This system requires the N/C programmer to input complex data tables into the computer system to set parameters controlling the optimization process. The software analyzes the programmed motion and feed-rates, then slows it down when it detects a plunging motion, speeds it up when “air cuts” are detected and tries to smooth out heavy cuts and light cuts to maintain a constant metal removal rate. The down side to this software system is that it is very time consuming for the programmer to prepare the data tables and parameters used and the system never really takes into consideration the actual conditions encountered at the machine tool during the cutting process. These conditions may include a lack of rigidity, poor cutter performance, material problems or any unforeseen difficulties encountered by the operator.

4) Another method used by a company called OMAT Control Technologies is to install sensors on the machine tool. These sensors detect horsepower changes and based on parameters loaded into a database, the feed-rates are modified accordingly. One problem with this package is the difficulty in analyzing the horsepower used on small cutters and tools. Like the G-Tech product mentioned above, setup and rigidity factors are not taken into consideration and no control is provided to overcome these types of problems.

It is desirable to provide an automated, computer controlled system permitting computerized analysis of the feed-rate and spindle speed over-ride controls and permitting optimization of the feed-rate of a CNC machine responsive to manual adjustment of the feed-rate and spindle speed over-ride controls to thereby establish an event file or an optimized machine control computer file which may be subsequently utilized to produce like parts in efficient and productive manner.

### SUMMARY OF THE INVENTION

It is a unique feature of the present invention to simultaneously utilize two independently developed sources of stored function control data to control a CNC machine, the first being a N/C program which is programmed into a CNC memory and the second being an over-ride and function log or file, which is separately programmed responsive to manual function control adjustment during active machining and is separately stored in the memory of a LAN or local PC and is made active to the over-ride and function mapping executable program of the CNC memory.

It is a another feature of the present invention to provide a novel system for automatically modifying the machine control data file of a CNC machine or constructing an “event file” which is automatically programmed to record data reflecting changes to the feed-rate and spindle speed over-ride controls made by the machinist to manually optimize the production performance of the machine for a part being machined and thereby ensure efficient and productive machining of like parts;

It is another feature of the present invention to provide a CNC machine, not having an “Open” or PC based CNC control, with a hardware interface device which facilitates the computerized analysis of the either the active block number or similar information and feed-rate and spindle speed over-ride controls throughout the machining process;

It is also a feature of the present invention to provide a method or process for optimization of the feed-rate of CNC machining by providing a CNC machine with a computer (if necessary) by which the functions and information of the machine tool control are available and having the capability to receive manually overridden values and establish therefrom an event file for subsequently controlling machining of like parts;

It is another feature of the present invention to provide for optimization of the productivity of CNC machines by accomplishing minor modification of the ladder programs and the operating system within the CNC control to allow the feed and speed controls to be over-ridden by means of an event file which is electronically established responsive to the manual adjustments of the speed and feed controls of CNC machines which are performed by the machine operator during actual machining activity;

It is an even further feature of the present invention to provide for optimization of the productivity of CNC machines by generating an event file responsive to machine operator controlled manual adjustments of the feed and speed controls of the machine and subsequently utilizing the event file to over-ride or command the feed and speed over-ride controls in lieu of the machine tool operator on subsequent production;

It is also a feature of the present invention to provide for optimization of the productivity of CNC machines by machine tool operator controlled fine tuning of speed and feed controls to generate one or more additional fine tuned event files which are subsequently utilized for controlling the feed-rate and spindle speed over-ride values of the CNC control;

It is another feature of the present invention to provide a novel system for optimization of CNC machine tool productivity which can take the form of an “event file” which is electronically written to an external data storage device for subsequent use as desired to over-ride the feed-rate and spindle speed over-ride values of a CNC control; and

It is also a feature of the present invention to provide for analyzing of an event file and calculating original machine times as compared to optimized machine times to thus provide for dynamic reporting of machine productivity, which reporting information can be transmitted automatically to networked computers for management of machine resources.

The purpose of this invention is to improve productivity at the machine tool by any means of automatically electronically incorporating into an “event file”, data reflecting the changes to the feed-rate and spindle speed over-ride controls as well as other machine function changes that are made by the machinist during actual machining activity, thereby optimizing subsequent production with the use of the event file.

Briefly, the various objects and features of the present invention may be realized by either interfacing the machine control with an IBM compatible personal computer (PC) or by modifying the ladder program and logic within the machine control to provide the CNC control with the capability of electronically generating an event file responsive to manual changes in feed-rate and spindle speed made by the machine operator during actual machining activity. During machining of a part, to manually optimize the production rate for the part being machined, the machinist will manually over-ride the feed-rate and/or the spindle speed and thereby optimize machining performance. Through the use of VISUAL BASIC OR C++ programming modules and routines or any pertinent programming system language, the speed and feed controls are polled at frequent intervals. The status or over-ridden values of these controls are correlated to the active block number in use during each polled sequence and this information is electronically written to an “event file”. After the subject part has been completed, the event file can be used in one of two ways: An “edit phase” can be initiated which utilizes the information in the “event file” to reconstruct the MCD file. After the edit phase is complete, the resultant output “optimized MCD” can be used to produce like parts with confidence that all motion is running at peak performance and all programmed trajectories are maintained. The cycle can be repeated again (if desired) to ensure even greater efficiency while cutting. In the alternative, the event file can be completely separate from the MCD file and employed in conjunction with the MCD file to “command” the CNC control with respect to feed-rate, spindle speed over-ride settings and other manually adjustable function changes that are made by the machinist during the machining of a part.

### PHASES OF OPERATION

1. Data Acquisition (Record Function)

This phase involves recording the operator's use of the feed-rate and spindle speed over-ride controls or other manually activated functions on the CNC machine tool during the machining of an actual part on the CNC machine to be used for production. It is a unique feature of the present invention to utilize a data acquisition sub-routine to accurately analyze the point in time that the operator imposes a manually activated function relative to the time that a block of data becomes active in the CNC control. An example of feed-rate over-ride intervention is shown in FIG. 2.

2. Naming and Up-Loading of Over-Ride Log

Upon completion of the data acquisition phase, the over-ride log is saved to a LAN. Alternatively the data may be saved to the local PC. It is a unique and important feature of the present invention to link the over-ride log data with the associated N/C Program. It should be understood that future optimized production of the subject part would be accomplished by simultaneously utilizing the N/C Program and the associated over-ride log. Several versions of the over-ride and function log may be maintained to allow for alternate cutter packages, alternate material, and alternate machines. The naming conventions used to link the over-ride and function log's to their respective N/C program should allow for this flexibility.

3. Recalling Operational Data

In preparation of optimized production with the present invention, the system must recall two separate data sources. The first data source is the N/C Program. This file is retrieved from a LAN or a local PC and is loaded into the CNC memory. The second data source is the over-ride and function log. This file is also retrieved from a LAN or local PC and is made active to the over-ride and function mapping executable program.

4. Human Activity Storage Program Mapping (Run Function)

The present invention, utilizes an “HASP mapping” software program to read the status of the CNC control during the machining process and send over-ride and function data to the PMC at the appropriate time. This phase requires accurate analysis of the specific block being processed and also the point in time that the block became active. Because the over-ride and function data file accurately captured the active block number, the number of milliseconds into the block that an over-ride or operator enacted function occurred and also the percentage of the over-ride, the present invention is capable of developing a plurality of feed-rate over-rides and a plurality of spindle speed over-rides and a plurality of operator initiated functions for any active block of data thereby duplicating the operators input during the data acquisition process.

Therefore it is a unique feature of the present invention to simultaneously utilize two independently developed sources of stored electronic data to control a CNC machine. Both data sources being developed by skilled individuals, one being the N/C programmer responsible for establishing both the co-ordinate values used for positioning and generally acceptable but not necessarily optimum feeds and speeds. The second, being the lead machinist, who is responsible for fine-tuning the machining process. His efforts produce the over-ride and function file that will most effectively utilize the associated N/C program to make the specific part from a certain type of material held in a specific fixture using a group of cutters.

5. Fine Tuning

Improvements to the over-ride and function log may be required. This is advantageous because subsequent machining may reveal further opportunities for improvements to the machining process. Additional reasons include newly acquired cutters that may allow increased feeds and speeds. Newly approved part materials, would require a change in the speeds and feeds. It is also a unique and valuable feature of the subject invention to facilitate the additional imposition of feed-rate and spindle speed over-ride data into the existing and previously stored human activity storage program (HASP) data by means of further sampling of the over-ride controls while simultaneously using the previously established HASP data.

It is also a unique feature of the present invention to provide for the ability to implement a larger percentage over-ride to the CNC control than is normally available to the PMC. When operating under the fine-tune mode, it is possible to read an over-ride and function log with values of 200%. If the operator imposes an additional 50% (150%) over-ride during this fine-tune operation, then the actual over-ride value will be 250%. This is possible when the subject invention is utilized on several common well-known brands of CNC controls that have an arbitrary limit of 200% on the feed-rate override control. (Note: a maximum of 255% us usually a limit because the maximum eight-digit binary number (11111111) equates to 255.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 a block diagram type schematic illustration showing a CNC machine having a control computer that is controlled with a machine control data file and being coupled with a personal computer via an interface device to permit an event file to be established by the personal computer responsive to manual feed-rate and/or spindle speed over-ride adjustments by the machine operator, which event file is used for editing of the machine control data file or controlling of the CNC feed-rate and/or spindle speed over-ride values; and

FIG. 2 is a block diagram electronic schematic illustration showing electronic generation of an event file responsive to manual adjustments of feed-rate and spindle speed over-ride controls of a CNC machine and the subsequent use of the event file for optimizing operation of the CNC machine;

FIG. 3 is a block diagram electronic schematic illustration showing the general construction of a machine tool utilizing the subject invention and the associated network system;

FIG. 4 is a block diagram electronic schematic flow chart illustration showing the RECORD and RUN processes of the CNC machine control system of the present invention and showing feed-rate override intervention in relation to machine control functions under the control of the N/C program of a CNC machine;

FIG. 5 is a block diagram electronic schematic flow chart illustration showing the FINE-TUNE function of the CNC machine control system of this invention;

FIG. 6 is a data table showing a sample N/C program and several reference parameters;

FIG. 7 is an illustration of a table showing a sample manual control intervention log developed during the data acquisition process, with each row of data representing a manual control intervention array;

FIG. 8 is an illustration of a table showing a sample manual control intervention log developed during the data acquisition process, which, for purpose of simplicity showing only data representative of feed-rate over-rides;

FIG. 9 is an illustration of a table showing the over-ride mapping process and, for the purpose of simplicity, showing only feed-rate over-rides, it being understood that data representing manual adjustment of other machine functions, such as spindle speed rate, coolant select, light on/off, door open, etc. and with the optimized run time being the actual time required to perform the optimization process;

FIG. 10 is an illustration of a graph showing the over-ride log, for the purpose of simplicity, showing only feed-rate over-rides, and noting the relative time in block that the over-ride takes place; and

FIG. 11 is an illustration of a graph showing the resulting feed-rates of the sample N/C program after over-ride mapping has implemented the over-ride data, and for the purpose of simplicity, showing only feed-rate over-rides.

### DETAILED DESCRIPTION OF PREFERRED EMBODIMENT

### GLOSSARY OF TERMS

N/C Program

A file of data established usually by an N/C Programmer that is used to control the functions of a CNC machine.

HASP File

The “Human Activity Storage Program” file is data established by the machine tool operator during the initial machining process. The data contained are block numbers or block count, time in block that a manual intervention took place, what the intervention was (feed or speed over-ride, function switch change such a single block, block delete, etc., conveyor on/off, work light on/off, coolant select, feed hold, jog, manual position of the axis etc.

HASP Mapping

The process of coordinating the N/C program with the HASP file. This coordinating process is accomplished by utilizing a computer program to accurately send operator recorded information (HASP data) to the CNC/PMC at the appropriate time or by automatically editing the N/C program thereby duplicating the operator induced changes.

Open Control

A CNC control that can easily exchange data and communicate with a personal computer or other common computer technology.

P/C Based Control

A CNC control that is based on the characteristics of a personal computer. The P/C based control may or may not utilize a P/C based operating system.

Data Acquisition

The process of polling the CNC control in order to detect and record any operator induced change including but not limited to feed-rate over-ride, spindle speed over-ride, or any other machine tool device or function detected by the PMC or PLC. The process will establish the block and the time within each block that any intervention occurred.

Down Load

The process of the CNC control or a P/C based control of retrieving a file or information from a LAN or other permanent storage device.

Up Load

The process of sending data from the CNC Control or the P/C Based Control or Linked P/C to a LAN system or other permanent storage device

PMC

Programmable Machine Controller is a software program typically found on CNC machine tools. The program is used to interface the CNC control with the machine tool function switches and devices. The functions or devices normally linked are the feed and speed over-ride controls, coolant type switch, function switches, conveyer controls, lights, function knobs and controls etc.

LAN

Local Area Network

Fine Tune

The process of recording additional operator initiated data to an existing human activity storage program file for the purposes of improving the process.

Technology Symbol

The symbol, designed by applicant, which represents two sources of stored data being used to provide simultaneous control over a single process.

[image]

CNC machines generally operate at pre-programmed feed-rates and spindle speeds determined by the N/C programmer. A major challenge facing manufacturing companies is to ensure that costly machine tools are operated at optimum performance levels. Quite often, the machine control data (MCD) of a CNC machine is adequate for producing a dimensionally correct part, but the productivity level of the machine may be inferior. Generally, the feed-rates established by the programmer are based on the programmer's level of knowledge or the programmer's concern to make a visually esthetic part rather than to optimally utilize the machine tool. The machining productivity of the machine and the service life of the machine and the various cutters being utilized are in large measure dependant on maintenance of optimum feed-rates and spindle speeds throughout the entirety of the machining operation.

### Technical Concept

The principles of the present invention are realized by either modifying the CNC computer's ladder program and operating system as required or interfacing a CNC machine tool's control system with an IBM compatible PC computer or other suitable computer. With the use of high speed fiber optic data transfer, all functions and information of the control system of the CNC machine will be available at the personal computer. The optimization process is actually performed by the operator while machining the subject part and making periodic manual adjustments with the feed-rate over-ride control and the spindle speed over-ride control of the machine to achieve machining of the part at the machine tools optimum capability.

Through the use of Visual Basic or C++ programming modules and routines or any pertinent programming language, the speed and feed controls are polled at frequent intervals, for example 500 ms intervals or at any interval range that is deemed suitable by the operator or programmer of the machine tool. The status or over-ridden values of these controls are correlated to the active block number in use during each polled sequence and then this information is written to an “event file”.

After the subject part has been completed, one of two options can be initiated. The first option uses the “event file” to provide for control of the CNC machine through the ladder interface of the feed-rate and spindle speed controls of the CNC Control. Alternatively, an “edit phase” is initiated. This process utilizes the information in the “event file” to reconstruct the MCD. This process consists of the following. All motion blocks are analyzed and, if required, modified to duplicate the conditions of the feed-rate and spindle speed over-ride controls used during machining. If multiple feed-rates are required for a single block of information, that block will be divided into multiple blocks of information each containing the proper departure move and spindle speed or feed-rate directed by the operator.

After the edit phase is complete, the resultant output “Optimized MCD” can be used to produce the product with confidence that all motion is running at peak performance and all programmed trajectories are maintained. The cycle can be repeated again (if desired) to ensure even greater efficiency while cutting.

### Hardware Requirements

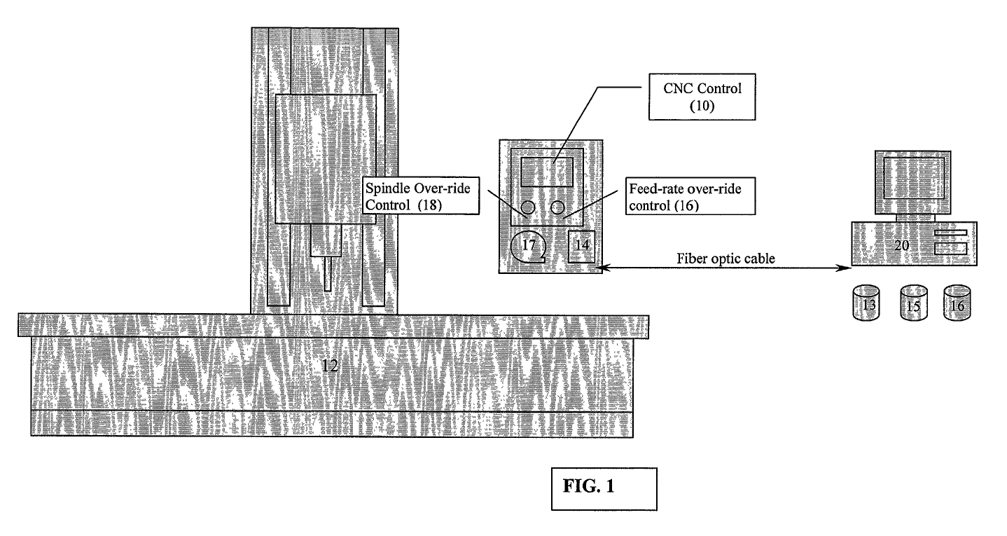

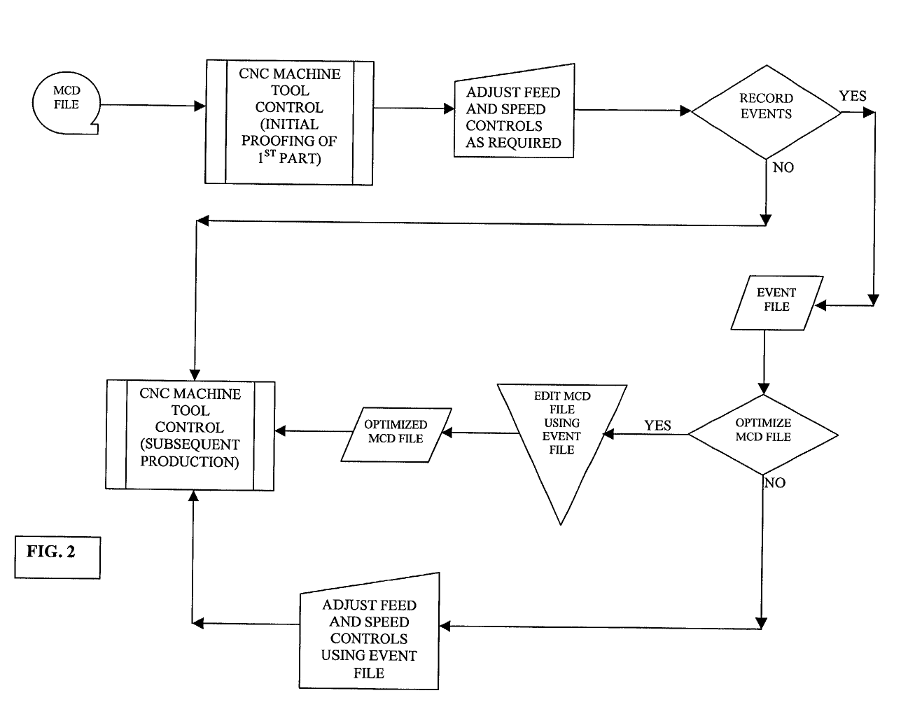

Referring now to FIG. 1 of the drawings, one embodiment which incorporates the principles of this invention causes the machine tool control 10 of a CNC machine 12 be fitted with a hardware interface device 14 which will facilitate the computerized analysis of the active block number, feed-rate over-ride control 16 and spindle speed over-ride control 18 by a personal computer 20 in communication coupled relation with the interface device 14 throughout the machining process. It should be borne in mind that a personal PC computer is not a requirement to enable the practice of the present invention, but may enable existing CNC machines to be adapted for use according to the principles of the present invention. In the case of CNC machines equipped with an “Open” or PC based CNC control, or a control that can be configured by modification of the ladder logic, a hardware interface and/or personal computer is not required, as the information relative to the active block number, feed-rate and spindle speed over-ride values are available for computer analysis.

### Software Programs

A software program written in “Visual Basic”, “C++” or any pertinent programming language is run (during the machining process) to poll or sample the current condition of the feed-rate and spindle speed over-ride controls during each block number throughout the machining cycle. The polling or sampling rate is anticipated to be between 100 ms and 500 ms intervals, or at any other suitable interval, beginning at the start of and continuing through the duration of each block number in the MCD file. The polling interval range, for example, may be within the range of from about 50 ms to about 1000 ms or may be higher or lower if desired. The software program of the personal computer or the CNC control will write an ASCII output file or any suitable file format (“event file” or “optimization file”), that contains a series of records. Each record consists of a block number, associated time value (ms), feed-rate over-ride setting and spindle speed over-ride setting. The feed-rate and spindle speed over-ride settings are the To values in effect at each 500 ms sampling. To minimize file size, data is written to the event file only if the program of the personal computer detects a change in the feed or speed over-ride controls. After the machining cycle for that particular part has been completed, the event file is named, closed and then re-opened for use to “command” or “edit” the CNC control with regard to feed-rate and spindle speed over-ride settings.

### Concept

When optimizing a CNC program, the operator of the CNC machine is encouraged to manually over-ride feeds and speeds to obtain the most efficient and optimum cutting conditions throughout the machining process. During the process, the operator may receive feedback in the form of computer-generated messages and/or warnings to keep the operator cognizant of the current and recommended chip load values, horsepower usage and current and recommended surface speed. This information, along with the normal visual clues, sounds and vibrations encountered during the actual cutting sequence provide the operator with the information the machine operator inherently uses to adjust the feed-rates and spindle speeds.

### Use of Equipment for Development

I. The CNC control's selected for initial development of the software is the Fanuc model 15M, 16M, 18M, and 21M. These machine controls are extremely popular in the manufacturing industry and markets. Development and testing will be accomplished under actual cutting conditions. It is to be noted that this configuration is only one method to accomplish the task of dynamically optimizing the feeds and speeds through the sampling or polling of the feed-rate and spindle speed control knobs of the CNC Control.

II. Computer Hardware (utilized for adapting existing CNC machines and for particular machine application, but not required for practice of the present invention)

a. A Pentium II 450 mhz computer with 128 MB of ram is recommended.

III. Hardware interface

a. CNC Side Fanuc A20B-8001-0290 PCB Interface

b. PC Side Fanuc A20B-8001-0580 PCB HSSB Interface

c. Optical Fiber Cable Fanuc A66L-6001-0026/L5R003

IV. Software for interface

a. Fanuc A02B-0207-K730 Windows 95 Driver/Library Disk

b. Fanuc A02B-0207-J800 Extended Driver & Library FCN.

V. Optimization software

a. VISUAL BASIC OR C++ programming language will be used for all software.

b. A Windows environment will be used on the PC.

c. The machinist may select menu options prior to the optimization process. This will configure the system to set limitations regarding maximum spindle speeds and feed-rates of the machine tool.

d. The initial development software may contain soft controls for feed-rate and spindle speed control. These controls will display the over-ride values being sampled by the program.

e. Each active block of information is analyzed at approximately 500 ms intervals or any other suitable interval to determine current Block Number, X,Y,Z,A,B co-ordinates and feed-rate and spindle speed over-ride values. These values are to be logged in the event file.

f. Upon completion of the optimized run, the machinist will activate a batch program by selecting a menu option. This routine will modify the MCD file by inserting and/or modifying XYZAB values based on the values obtained from the event file. The optimized MCD file is then placed in a directory, which may be selected by the operator for productive use.

g. As an alternative to item “f”, the event file may be used directly to control or command the feed-rate and spindle speed over-ride parameters in the CNC control.

CNC machinery is used throughout the world. All modem manufacturing companies rely on this technology to provide cost effective and consistent products. Several industries can greatly benefit from this product. The aerospace and automotive industries are just a few of the many. Two markets have been identified. First, new machine tool builders can be licensed to include the “Dynamic Feed Control” option of the present invention on new machinery. Second, existing machine tool users can have conventional equipment retrofitted to use the “Dynamic Feed Control” option. This may or may not (depending on the CNC Control) require the addition of interface hardware. The retrofit business is very broad and includes small machine shops, mid-size suppliers to both the automotive and aerospace industry as well as the prime contractors of both industries.

The system can be used in one of two ways. The method of use is determined by the limitations of the CNC control or the desired means of commanding the feed-rate and spindle speed over-ride controls of the machine tool.

The first method requires the Machine Control Data file (MCD) to be edited and reconstructed by implementing the feed-rates and spindle speeds stored in the event file. This edit process is accomplished by batch processing the MCD file while the event file dictates the changes to be made. A Visual Basic, C++, or any similar programming language can be used to perform the editing of the MCD file. The edit program will assign, or re-assign the “F” values and “S” values of all blocks of information required to match the values established in the event file. If a block of information is found to have multiple feed-rate and or spindle speed values, that block will be divided into multiple blocks, each containing the appropriate feed-rate and departure commands. It is understood that the editing of feed-rates or spindle speed information must not change the cutter trajectory. Therefore, double precision editing techniques are to be used to ensure that the tool path is not modified.

The second method assumes that the event file can directly or indirectly control the feed-rate and spindle speed over-ride values sent to the CNC control. If the CNC control is an open type (PC based) or if the CNC control is interfaced with a PC based control system or if the CNC control is modified by proper ladder edit techniques and control system editing, then values obtained directly from the event file are used to command the feed rate and spindle speed over-ride functions.

### I. HARDWARE AND GENERAL DESCRIPTION OF OPERATION

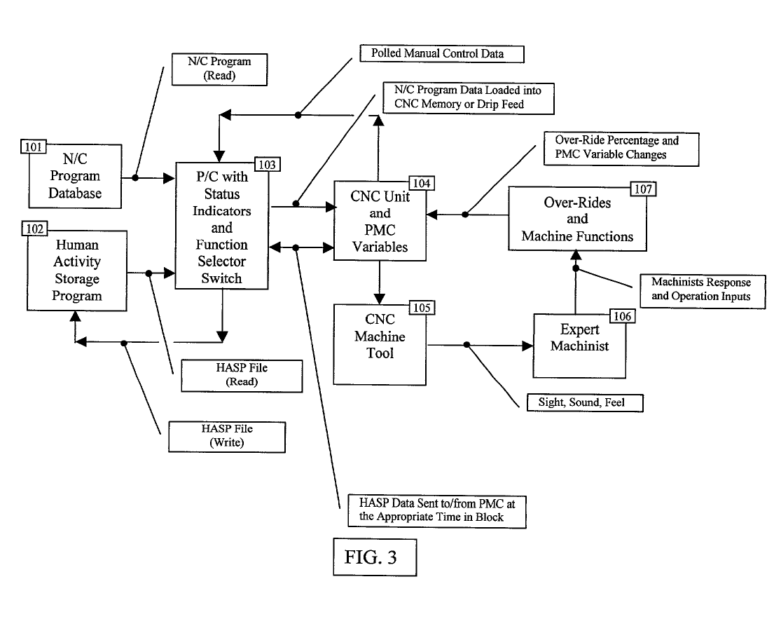

Referring to FIG. 3, it is noted that two sources of information are maintained are and are used to provide optimum control of the CNC machine tool. The first source of data is the N/C program database 101 and is derived from the N/C programmer. This file is a typical N/C program and no special data is required within the program. The second source of data is the over-ride and function log database 102, which is derived from the process of an experienced machinist running the initial part on the subject CNC machine tool and applying over-rides and other machine control intervention. The P/C 103 is connected to the two sources of control data 101 and 102 by means of a LAN. The P/C is also is connected to a CNC Unit 104 by means of a high-speed communication device such as a fiber optic cable. Alternatively, the P/C may be omitted and an Open or P/C Based CNC control may be used which, will contain the required software to perform the noted functions.

While machining an initial part, the machinists 106 manipulation of the over-ride controls 107 and Function controls are in response to the sight, sound and feel the operator detects while machining the initial part or additional machine functions he deems are appropriate to activate during the machining process. As the operator imposes changes to the over-ride control functions, the machine tool 105 responds either favorably or unfavorably and the machinist will further over-ride as deemed appropriate. During this process, the status of the over-rides 107 and other machine function controls are regularly polled by the P/C 103, and the polled information derived thereof is written to a temporary over-ride and function file. Upon completion of the recording process, the temporary file containing the analyzed data is permanently written to the over-ride and function log database 102.

When machining the remaining parts, the CNC control will be controlled and influenced (as noted earlier) by two sources of permanently stored data. The main controlling source of information is the N/C program. This program contains the information normally found in a standard N/C program such as G-codes, M-codes, block numbers (if desired), and coordinates used to control the positioning along with the F-words and S-words (feed and speed commands). The secondary source of information is the human activity storage program (HASP) file. This file will contain data that reflects the actions taken by the skilled machinist when machining the initial part. An example of the type of data that is included is the following: feed-rate over-ride, spindle speed over-ride, coolant on/off, coolant type (flood or mist or oil), work light on/off, conveyor on/off, door open/close, feed hold, spin window on/off, or any other type control that may be desired to be incorporated into the manufacturing process. The important point to remember is, this is the type of information that the machinist may wish to impose into the process in order to improve the pre-programmed process.

Continuing now, to the production process, when the operator wishes to machine the remaining parts, he downloads the N/C program to the CNC control. Because the P/C 103 is used for this process, it is possible to determine the file name being downloaded and therefore, the associated over-ride and function log (HASP file) can also be downloaded to the P/C. To machine the production part, the operator selects the “Run” function on the P/C and the message “Press Cycle Start” is displayed. The operator presses cycle start and the CNC control 104 initializes and reads the first block of information. The P/C 103 queries the CNC control for the active block and if an over-ride array with a matching block number is contained within the over-ride and function file, that associated over-ride value is sent to the CNC control variable assigned to handle the appropriate over-ride function (feed or speed). Note that the over-ride data being sent is the percentage derived from the teaching process. It is sent at the relative point in time (within the block) that was established during the teaching process. Human activity storage program data will continually be sent by P/C 103 to the CNC unit 104 at the appropriate time throughout the machining of the part. It is also important to understand that the over-ride controls 107 are not disabled during this process. The over-ride data sent is actually multiplied by the current condition of the associated over-ride control and this, allows the operator to maintain control of the machine tool even though the HASP is being sent. Upon completion of the part the CNC will encounter an M30 or M02 code in the N/C program and will act accordingly. The P/C 103 will detect this condition and reset to the condition of ready for a new part to be loaded.

### II. THE SOFTWARE

### Data Acquisition Subroutine (Record Function)

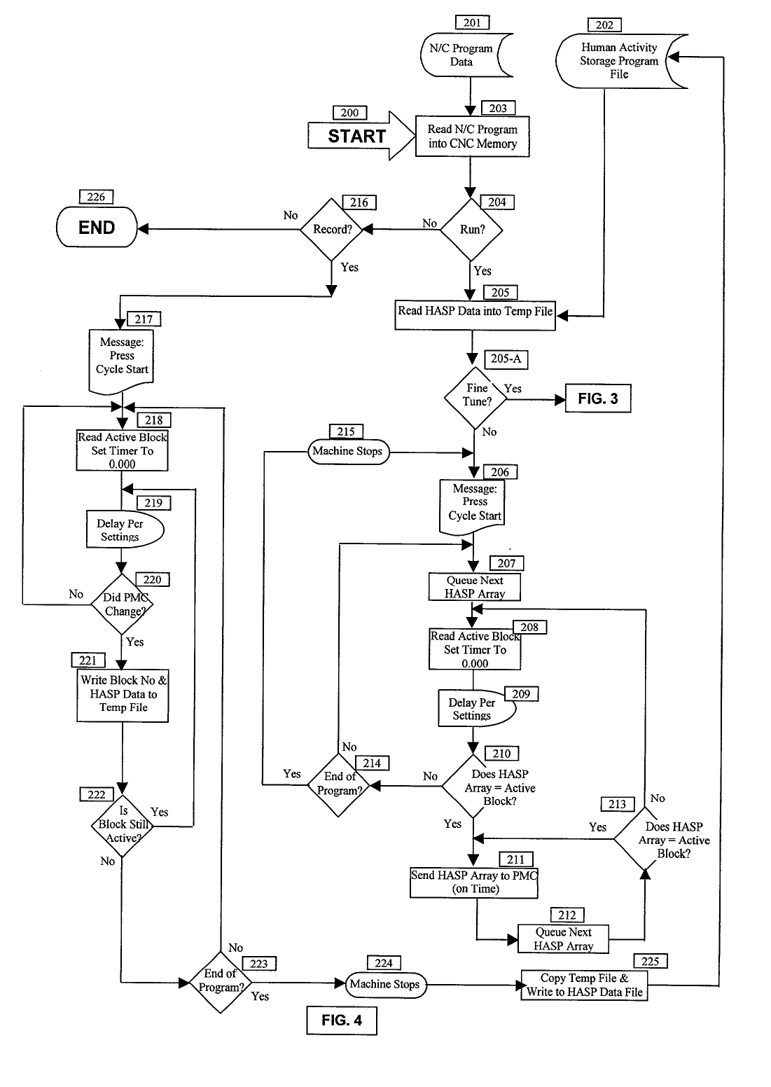

Referring now to FIG. 3 and FIG. 4, the process of recording an event file will be understood. This process begins with the operator initiating the loading of the N/C program into the CNC memory. As this process is completed, a menu option is displayed on the P/C monitor. The machinist is requested to select either the “Run” or “Record” function. In this case, the record function 216 is selected and the DFC system will prepare to receive data by initializing a temporary file used to contain HASP. The message “Press Cycle Start” is displayed at the P/C and the operator will initiate the machining process by pressing the cycle start button on the CNC machine tool 105.

The DFC system is installed and configured to “poll” the CNC Control at regular intervals (approximately 20 milliseconds). The polling process evaluates the active block either through block-count or block-number (sequence number) depending on the configuration. Analysis of the CNC Control reveals the active block and the moment the block becomes active the internal timer 218 is set to 0.000. The over-ride variables and other PMC variables within the CNC control are polled to determine if a change takes place. If a change in the O/R 220 or machine functions monitored by the PMC takes place, the active block, relative time into that block, and percent of over-ride or machine function modified is written to the temp file 221, and further polling continues. If the active block is still in effect, the over-rides and PMC functions will continue to be monitored and operator induced data will continue to be written (if changes occur) for the active block until a new block is detected. When a new block is detected, a check is used to determine if the end of program has been reached 223. If it has not been reached, control is passed back to the block read segment 218 and the process continues.

If the end of the N/C program is reached an M30 or an M02 will be encountered and step 223, initiates the normal reset sequence 224 and the process of filing HASP is initiated 225. This process will name the associated HASP file, thereby ensuring that the file name is linked to the associated N/C Program used.

### Human Activity Storage Program Mapping (Run Function)

Referring to FIGS. 3 and 4, the process of running a production part will be reviewed. Again as in the “Record” function, the machinist is required to download the N/C Program data 201 into the CNC control 104 memory. After the download process is complete the machinist is queried to either “Run” 204 or “Record” 216. In this case, the machinist selects the “Run” menu item and because the P/C 103 was used to download the N/C program, the associated HASP file can be identified and downloaded to the P/C. After reading the HASP file, the machinist is signaled to “Press Cycle Start”. He will, at that time activate the CNC machine and the software will once again begin a polling process of the CNC Control 203. As soon as a block becomes active, the internal timer 208 is set to 0.000 and a check is made to see if the current array contains the block number that is active 210. If the array contains the active block, the over-ride array containing the percent over-ride value will be sent to the CNC (at the time matching the array) to over-ride the programmed feed 211. It should be noted that the over-ride switches are not disabled during this process but they remain in effect and are simply multiplied by the value contained within the array.

After the array has been sent, the next array is queued 212 and a check is made to determine if this array is also contained in the active block 213. If the array again matches the current block, then the next feed-rate over-ride value will be sent to the PMC at the matching time also contained within the array. The processes 211, 212, 213 will continue on being repeated until all over-ride data within the specific block has been sent. It is this routine that provides the ability to develop multiple feeds within a single block of information.

Continuing on through the CNC machining process, as new blocks of information are read, the system will match the corresponding over-ride array and send the data at the proper time. Once the “End of Program” is detected 214, the CNC machine cycle terminates as indicated at 215 and the DFC routines are reset to the cycle start point shown at 206.

The process of matching the human activity storage program file, HASP, with the N/C Program file is shown in FIGS. 6-9. Referring now to FIG. 8, a sample feed-rate over-ride map is shown. This data is developed during the “Data Acquisition” or “Record” process and will normally contain any human activity storage program data. This data may be feed-rate over-rides, spindle speed over-rides, feed holds, coolant selects, conveyor on/off, or any other manually activated functions that can be detected through the PMC-CNC logic. This example in FIG. 8, for the purpose of simplicity, shows feed-rate over-rides only; however the method used for recording all other manually activated features or functions is treated similarly.

It should be apparent that the block number and the associated time in block that the manual intervention takes place is required in order to ensure that the HASP is performed at the proper time within the block. As some blocks of information can take a considerable amount of time to perform, it is important that proper timing be maintained.

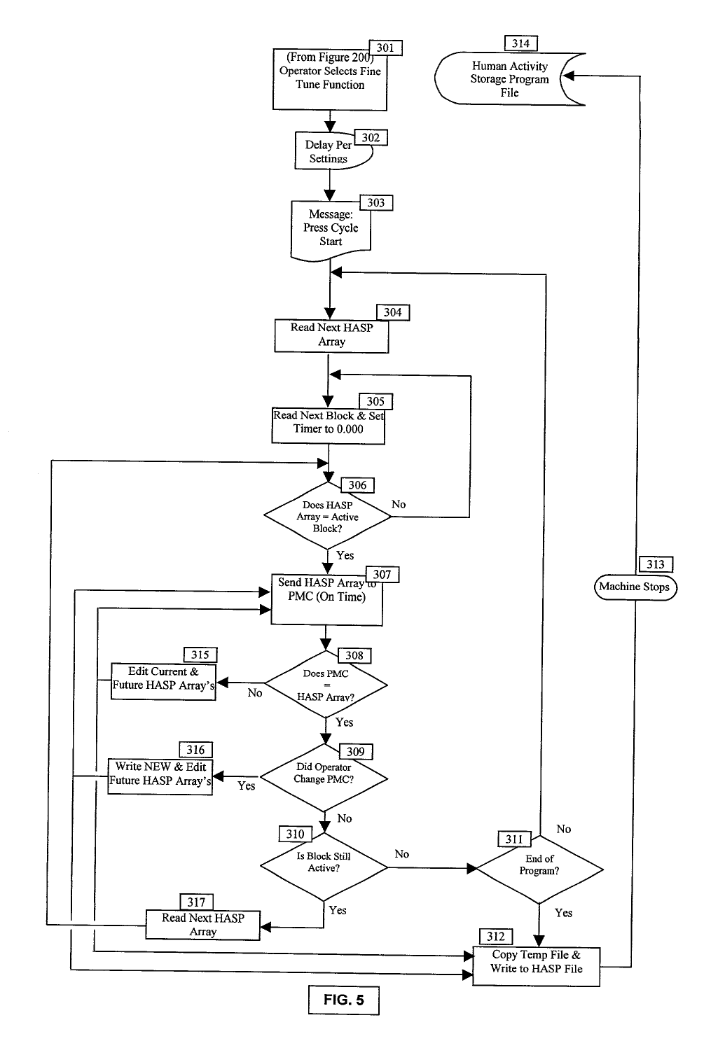

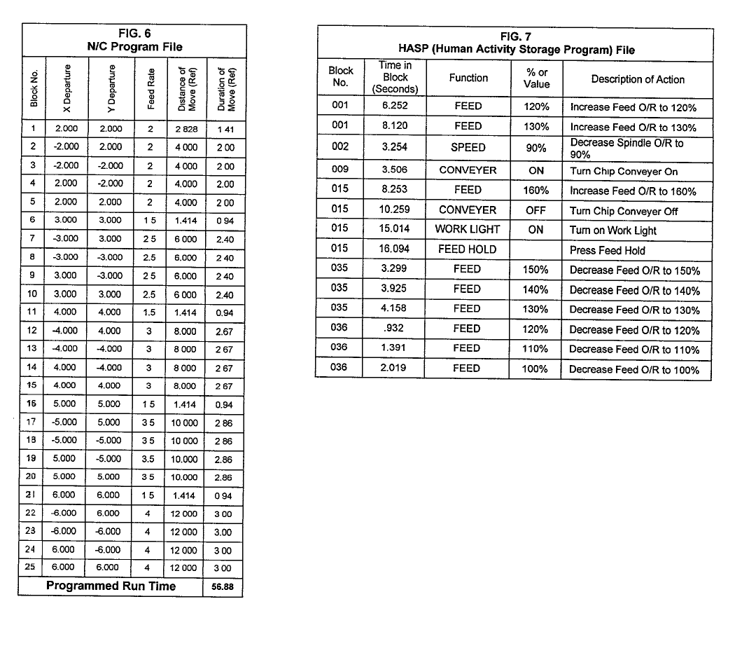

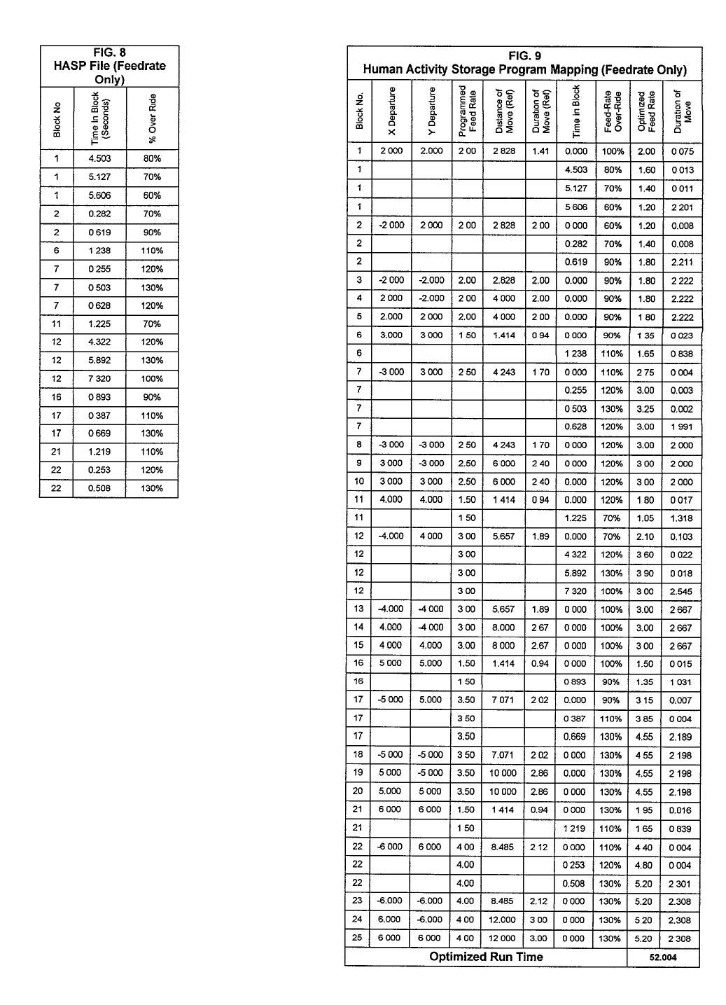

The “Over-Ride Mapping” process shown in the chart of FIG. 9 indicates the results of the optimization process. It should be noted that if a series of over-rides or manually activated functions occurs in one block of information, an array of over-ride and/or function data would follow. Each array will be sent to the CNC at the time contained in the array and each successive array will be sent until all arrays for that block of information have been sent. Then the next active block number will be analyzed and if it also contains over-ride data, then the next appropriate array shall be sent to the CNC at the appropriate time. For the purpose of simplicity, the example shown in the chart of FIG. 9 demonstrates manual control intervention mapping for feed-rate over-rides only. Similar mapping techniques are used for spindle speed and other manually activated functions on a CNC machine tool. The input data for the example of FIG. 9 is derived from FIGS. 5 and 6. When reviewing the manual control intervention mapping table of FIG. 9, it should be noted that the “Optimized Feed Rate” values are the results of the N/C program, the manual control intervention file and values calculated thereof. The “Optimized Run Time” shown at the bottom of the chart is the actual time required to perform the optimization process in itself.

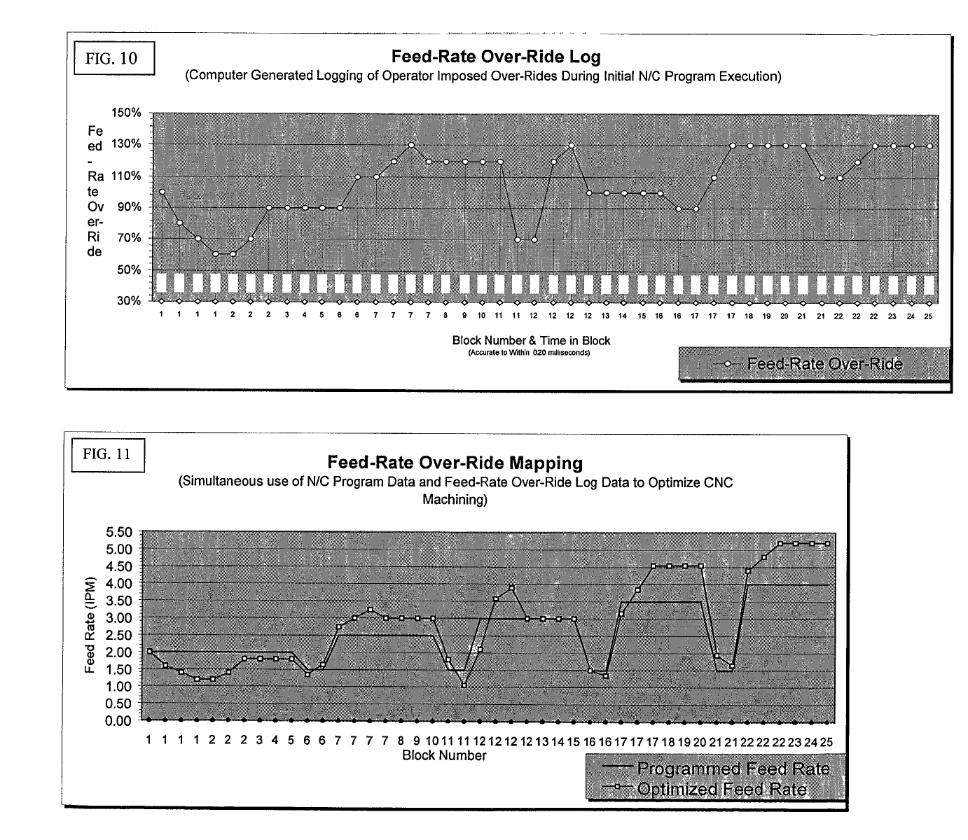

With reference to FIGS. 10 and 11, It is apparent that by applying the over-rides shown in the graph of FIG. 10 the programmed feed-rates and productivity derived thereof are increased as shown in the graph of FIG. 11. Because the machinist is able to slow down or speed up the feeds and speeds at will, only the range of over-rides provided by the machine tool manufacturer limits the machinists influence over the process. The machinist also has a broad range of manually activated functions and devices which can be incorporated into the production process for each subsequent part.

### Fine-Tune Function

Referring to FIGS. 3-5, the process of fine-tuning will be reviewed. Again as in the “Run and Record” function, the machinist is required to download the N/C program data 201 into the CNC control memory 104. After the download process is complete the operator is queried to either “Run” 204 or “Record” 216 as shown in FIG. 4. In this case, the machinist will select the “Run” menu item and, because the P/C 103 shown in FIG. 3 was used to download the N/C Program, the associated HASP file can be identified and downloaded to the P/C. In this case, the machinist will also select the “Fine Tune” function 205-A of FIG. 5. After selecting this function, program logic is transferred to the section of the program described in FIG. 5. As in the “Run” function, the “Delay” parameters 302 are established and the message “Press Cycle Start” 303 is displayed. The machinist will initiate the CNC machining process by depressing the cycle start button on the CNC control. At that time, the computer program will read the first available HASP array 304 and then the CNC control will, watch for a block to become active. When the block becomes active, the internal timer is set to 0.000 305 and a test is made to determine if the active block matches the HASP array 306. If the HASP array matches the block, the HASP array is sent to the PMC at the time specified within the HASP array. This action will modify the parameters of the PMC responsible for the variable that has been assigned. The variable may be feed-rate override, spindle speed override, or any manually activated PMC function. After the parameter is sent to the PMC a further test is made to determine if the machinist has modified the position of over-rides or has modified any of the function switches monitored by the PMC 308. If the machinist has modified any of the control switches, the current HASP array and all future or upcoming HASP array's will be edited to match the conditions found, as shown at 315. If no changes have been detected, then control is transferred to 309 and a test is performed throughout the duration of the HASP array. This test is used to determine if the operator has made any changes during the period the array 309 has been in progress. If a machinist change has taken place, then a new HASP array is written and all future HASP arrays are edited to ensure that they have been modified accordingly as shown at 316. If the machinist has not changed the PMC variables during the duration of the HASP array, a test is made to determine if the block is still active, as shown at 310. If the block is still active the next HASP array is read, as shown at 317, and control is returned to 306. If the test shows the block is not active, as indicated at 310, a test is made to determine if the end of the program indication has been encountered, as shown at 311. If an “End of Program” is not encountered, the software will transfer control back to 304. If an “End of Program” indication is encountered, all edited HASP arrays are copied and re-filed into the HASP database 314. This action will thereby improve the HASP data by incorporating into the file, additional intervention that the machinist may have deemed appropriate for further refinement of the machining process.

The present invention, as set forth in the specification above, provides a unique and novel method for the automated implementation of operator induced changes to a pre-programmed numerical control machining process. The methods used by the invention are unique and sufficiently accurate to provide for automated implementation thereof without further programmer or operator intervention.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A method for optimizing the machining capability of CNC machines, comprising:
operating a CNC machine responsive to a permanently stored machine control database;
manually adjusting one or more machine operating functions during machining to manually optimize the machining process, said manually adjusting simultaneously causing recording of adjustment induced changes of the machine operating function of said permanently stored machine control database and resulting in a modified machine control database; and
operating the CNC machine under control of said modified machine control database for optimizing machining of like parts.

2. A method for CNC machining, comprising:
conducting NC machining of a part with a CNC machine being controlled by a CNC control program representing a primary source of permanently stored data;
during machining of the part, introducing manual changes to the machining process by a skilled machinist manipulating manually actuatable controls of the CNC machine to optimize the machining process for the part;
responsive to said manual changes to the machining process and in real time concurrently with said NC machining, generating an electronic control program representing a secondary source of permanently stored data reflecting said manual changes; and
conducting subsequent machining operations with said CNC machine for optimized machining of like parts, with the CNC machine being controlled by said primary and secondary sources of permanently recorded data acting simultaneously.

3. The method for CNC machining of claim 2, comprising:
said step of introducing manual changes to the machining process being accomplished with respect to both timing and function values, ensuring duplication of optimized productivity of the machining process during subsequent machining of like parts.

4. A machining control system for controlling machining functions of a CNC Machine, comprising:
a first source of programmed permanently stored machine control data for controlling machining functions during machining;
a second source of permanently stored machine control data representing machinist adjustment input during actual machining of a part, for optimizing the machining operation for the part; and
said machining functions of the CNC machine being controlled simultaneously by said first and second sources of permanently stored machine control data.

5. A method of controlling the various functions of a CNC machine having a control system including a first source of programmed permanently stored machine control data for controlling machining functions during machining of a part and at least a second source of permanently stored machine control data representing machinist adjustment input during actual machining of the part for optimizing machining of the part, said method comprising:
utilizing said first and second sources of programmed permanently stored machine control data simultaneously for optimized machining of like parts.

6. The method of claim 5, wherein said first and second sources of programmed permanently stored machine control data are each separately and independently developed, said method comprising:
with said first source of permanently stored machine control data, controlling the machining functions of a CNC machine according to programmed instructions; and
with said second source of permanently stored machine control data controlling the machining functions of the CNC machine according to function override adjustments made by machine operating personnel during actual machining of a part for optimizing machining of the part.

7. A control system for a CNC machine, comprising:
a pre-programmed CNC control establishing a plurality of blocks of NC program instruction data for controlling the machining of a designated part; and
machine function adjustment programmed CNC control, programmed during actual machining of the part by machinist actuated adjustment of override adjustments of the CNC machine and establishing a plurality machining function adjustments within respective commanded blocks of NC program information, said machine function adjustment programmed CNC control operating concurrently with said pre-programmed CNC control for automated optimized machining of like parts.

8. A method for optimized CNC machining having a programmable CNC control and having machining function override controls, comprising:
programming said CNC control for establishing a plurality of blocks of NC program instruction data having feed-rates and spindle speeds for program controlled machining of a part;
establishing by manual adjustment of machining function override controls a plurality of feed-rates and spindle speeds within at least one block of said NC program instruction data; and
replaying on command said plurality of feed-rates and spindle speeds within said at least one block of said NC program instruction data for optimized machining of a like part.

9. A method for optimizing the feed-rate and spindle speed of a CNC machine having a control computer and a machine control data file and having an event file and further having feed-rate and spindle speed override controls, said method comprising:
operating the CNC machine for machining a part, said operating step being controlled by the machine control data file;
during said operating step conducting a computerized analysis of the active block number and feed-rate and spindle speed over-ride controls throughout the machining process;
during said operating step, selectively manually actuating the feed-rate over-ride control and/or the spindle speed over-ride control as desired for feed-rate and/or spindle speed optimization and by said computerized analysis establishing actual machining data in the event file including block number, feed-rate and spindle speed and corresponding time values; and
utilizing said event file for electronically controlling feed-rate and spindle speed over-ride controls during subsequent machining of like parts .

10. The method of claim 9, comprising:
editing the machine control data file with said actual machining data of said event file; and
conducting subsequent machining operations under the control of the edited machine control data file.

11. The method of claim 9, comprising:
directly controlling said CNC machine with said event file.

12. The method of claim 9, wherein said conducting said computerized analysis comprising:
periodically polling the current condition of the feed-rate and spindle speed over-ride controls and recording data representative thereof in said event file.

13. The method of claim 9, wherein said conducting said computerized analysis comprising:
polling the current condition of the feed-rate and spindle speed over-ride controls at intervals in the range of from about 50 ms to about 700 ms and writing data representative thereof in said event file.

14. The method of claim 9, wherein said writing data representative thereof occurs only in the event a change is detected in the feed-rate or spindle speed.

15. The method of claim 9, wherein said conducting said computerized analysis comprising:
with a software program, writing an ASCII output file, being said event file containing records consisting of a block number, associated time value, feed-rate over-ride setting and spindle speed over-ride setting.

16. The method of claim 15, comprising:
after completion of each machining cycle naming and closing said ASCII or other pertinent output file; and
opening and using said ASCII or other pertinent output file to command said programmable control data file with respect to feed-rate and spindle speed over-ride settings.

17. A method for optimizing the feed-rate and spindle speed of a CNC machine having a control computer and a machine control data file and having an event file and further having feed-rate and spindle speed override controls, said method comprising:
operating the CNC machine for machining a part, said operating step being controlled by the machine control data file;
during said operating step conducting a computerized analysis of the active block number and feed-rate over-ride control setting and spindle speed over-ride control setting throughout the machining process;
during said operating step, selectively manually actuating the feed-rate over-ride control and/or the spindle speed over-ride control as desired for feed-rate and/or spindle speed optimization and writing changes thereof in the event file including block number, feed-rate and spindle speed; and
using said event file for commanding said CNC Control feed-rate and spindle speed control functions with respect to feed-rate and spindle speed for the machining of a successive like part.

18. The method of claim 17, wherein said conducting said computerized analysis comprising:
periodically polling the current condition of the feed-rate and spindle speed over-ride controls and recording data representative thereof in said event file.

19. The method of claim 17, wherein said conducting said computerized analysis comprising:
polling the current condition of the feed-rate and spindle speed over-ride controls at intervals in the range of from about 200 ms to about 700 ms and writing data representative thereof in said event file.

20. The method of claim 17, wherein said writing data representative thereof occurs only in the event a change is detected in the feed-rate or spindle speed.

21. The method of claim 17, wherein said conducting said computerized analysis comprising:
with a software program, writing an ASCII or any pertinent output file, being said event file containing records consisting of a block number or any method to identify the current block of information being read, associated time value, feed-rate over-ride setting and spindle speed over-ride setting.

22. The method of claim 21, comprising:
after completion of each machining cycle naming and closing said ASCII output file; and
opening and using said ASCII output file to command said CNC Control with respect to feed-rate and spindle speed over-ride settings.

23. A CNC machine configured for performance optimized high production machining operations, comprising:
a machine tool having an adjustable feed-rate control system and an adjustable spindle speed control system;
at least one control computer being in assembly with said machine tool and having an event file for controlling the feed-rate and spindle speed of the machine tool;
a feed-rate over-ride control and a spindle speed over-ride control permitting selective machine operator controlled manual over-ride of the feed-rate and spindle speed established by said machine control data file; and
an event data file being in data receiving communication with said feed-rate over-ride control and an spindle speed over-ride control and being written with data representing changes of feed-rate and/or spindle speed control settings, said event data file being used to control the CNC Control feed-rate and/or Spindle Speed override values or edit said programmable machine control data file with respect to feed-rate and spindle speed over-ride settings.

24. A method of machining with a CNC machine having a manually programmable machine control data file for controlling machining functions and an automatically programmable event file and further having machinist adjustable function controls being manually adjustable during machining, said method comprising:
manually programming said machine control data file prior to machining and establishing a machining program;
conducting machining operations for machining a part under the control of said machining program of said machine control data file;
during machining of the part, manually adjusting the machinist adjustable function controls as desired by the machinist to optimize machining of the part, said manually adjusting automatically programming said event file responsive to manual adjustments made by the machinist; and
during subsequent machining of like parts, controlling machining operations with said machine control data file and said event file for machinist adjusted optimized machining thereof.
